(19) United States
(12) Patent Application Publication
(10) Pub. No.: US 2003/0210167 A1
(43) Pub. Date: Nov. 13, 2003

(54) Wireless remote-control light adjuster

(76) Inventor: Linsong Weng, Chu-Pei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/141,059

(22) Filed: May 9, 2002

(51) Int. Cl. G08C 19/00; H04L 17/02; G08C 19/12

(52) U.S. Cl. 341/176; 340/825.72

(57) ABSTRACT

The present invention provides a wireless remote-control light adjuster comprising a remote-control module and a light adjustment device connected to at least one light bulb. A key module for keying in internal codes of the light adjustment device and used as remote-control keys is disposed in the remote-control module so that the remote-control module can learn each internal code and simultaneously generates several remote-control digital codes. The remote-control module emits out a remote-control signal having different remote-control digital codes to the light adjustment device according to the change of pressed times of the remote-control keys on the key module. The light adjustment device outputs different degrees of electricity to the light bulb according to the remote-control digital code of the received remote-control signal. The present invention has the advantage of remotely controlling the brightness of light bulbs.

### FIELD OF THE INVENTION

The present invention relates to a wireless remote-control device and, more particularly, to a wireless remote-control light adjuster, which controls light bulbs in wireless remote-control way to generate different degrees of brightness.

### BACKGROUND OF THE INVENTION

Along with enhancement of living standards, people more appreciate savor of life. Light adjusters can change the light intensity of a light bulb so that a user can adjust the light at different places and different time, hence creating a whole atmosphere. Therefore, they become an indispensable design of most stores and residences emphasizing the mood. Presently, a light adjuster is usually fixed on the wall. One must go there to adjust the light adjuster himself, resulting in inconvenient operation.

Along with continual development of scientific technology, many people more emphasize convenience and agility in life, letting wireless remote-control way be widely applied in everyday life. In order to let people conveniently and flexibly control the operation of a light adjuster and help users inconvenient in actions controlling the operation of each light bulb themselves, the present invention proposes a wireless remote-control light adjuster capable of wirelessly controlling the light intensity of the light bulb.

### SUMMARY OF THE INVENTION

The primary object of the present invention is to propose a wireless remote-control light adjuster, which exploits mutual learning of internal codes of a remote-control module and light adjustment devices to let the remote-control module be capable of remotely controlling a plurality of sets of light adjustment devices for changing the brightness of light bulbs.

Another object of the present invention is to propose a wireless remote-control light adjuster, whereby a user can press the same key many times to continuously send out the remote-control digital code of the same light adjustment device, thereby achieving multi-stage change of brightness of a light bulb.

Yet another object of the present invention is to propose a wireless remote-control light adjuster, which utilizes the characteristic of mutual learning of remote-control signal to let light adjustment devices be capable of learning remote-control serial codes of different remote-control modules so that the remote-control modules having different remote-control serial codes can simultaneously control a plurality of sets of light adjustment devices.

According to the present invention, a wireless remote-control light adjuster comprises a remote-control module and a light adjustment device connected to at least one light bulb. A key module is disposed in the remote-control module. The key module is used for keying in internal codes of the light adjustment device. One can press a key to remotely control the light adjustment device. The remote-control module learns each keyed-in internal code and simultaneously generates a plurality of remote-control digital codes. The remote-control module emits out remote-control signals having different remote-control digital codes to the light adjustment device according to the change of pressed times of the key on the key module. A wireless receiving circuit for receiving remote-control signals is disposed in the light adjustment device. A brightness control module in the light adjustment device outputs different degrees of electricity to a light bulb according to the remote-control digital code of the received remote-control signal to change the brightness of the light bulb.

The various objects and advantages of the present invention will be more readily understood from the following detailed description when read in conjunction with the appended drawing, in which:

### BRIEF DESCRIPTION OF THE DRAWINGS

FIG. 1 is a structure diagram of the present invention;

FIG. 2 is a structure block diagram of a handheld remote-control module of the present invention;

FIG. 3 is a structure block diagram of a light adjuster of the present invention;

FIG. 4 is a graph showing an AC pulse wave; and

FIG. 5 is a structure block diagram of a telephone far-end remote-control module of the present invention.

### DETAILED DESCRIPTION OF THE PREFERRED EMBODIMENTS

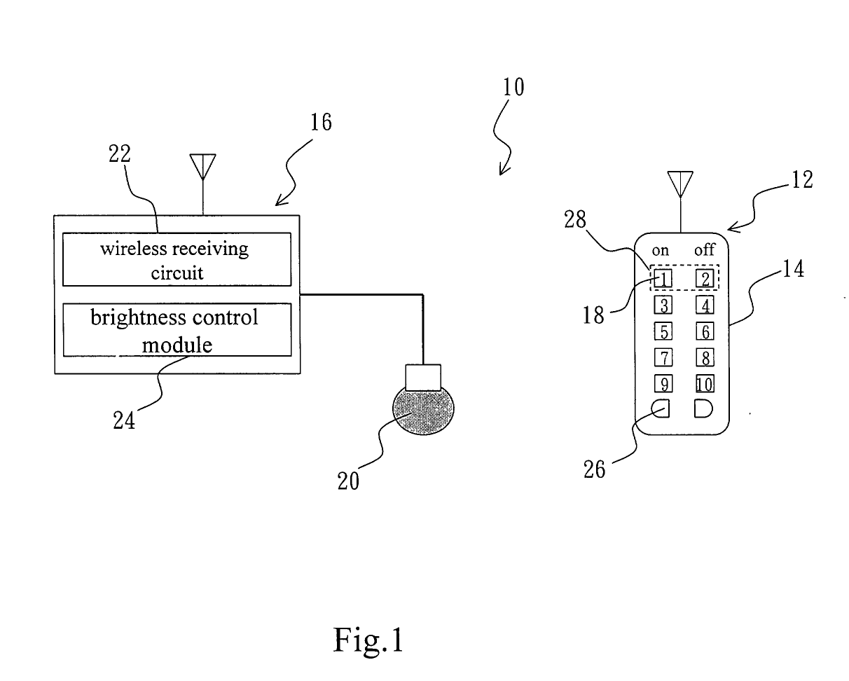

As shown in FIG. 1, the present invention comprises a handheld remote-control module 12 with a key module 14 disposed thereon. One can use the key module to key in a plurality of internal codes of a light adjustment device 16 so as to let the handheld remote-control module 12 learn each separate internal code. Matched with internal programs preset in the handheld remote-control module, each internal code forms a plurality of multi-stage remote-control digital codes. Through change of pressed times of an identical key 18 on the key module 14, the handheld remote-control module 12 continuously sends out remote-control signals having different remote-control digital codes to the same light adjustment device 16. Each light adjustment device 16 is connected to many light bulbs 20. A wireless receiving circuit 22 for receiving remote-control signals is disposed in the light adjustment device 16. The operation of a brightness control module 24 disposed in the light adjustment device 16 is controlled according to the remote-control digital code of the received remote-control signal. The light bulbs connected to the brightness control module 24 thus have different degrees of brightness according to change of remote-control digital code.

In addition to a plurality of remote-control keys, a copy/function switch 26 is also disposed in the key module 14. When the switch 26 is set to function, every two of the keys 18 are grouped as a control set 28. Each control set 28 includes an ON key and an OFF key, both corresponding to the same light adjustment device 16. Continuous pressing of the ON key controls circulatory light adjustment of the corresponding light adjustment device 16. The power of the light adjustment device 16 is turned off by pressing the OFF key once. When the switch 26 is set to copy, pressing of the key 18 can let the handheld remote-control module 12 learn and copy internal codes of each light adjustment device 16.

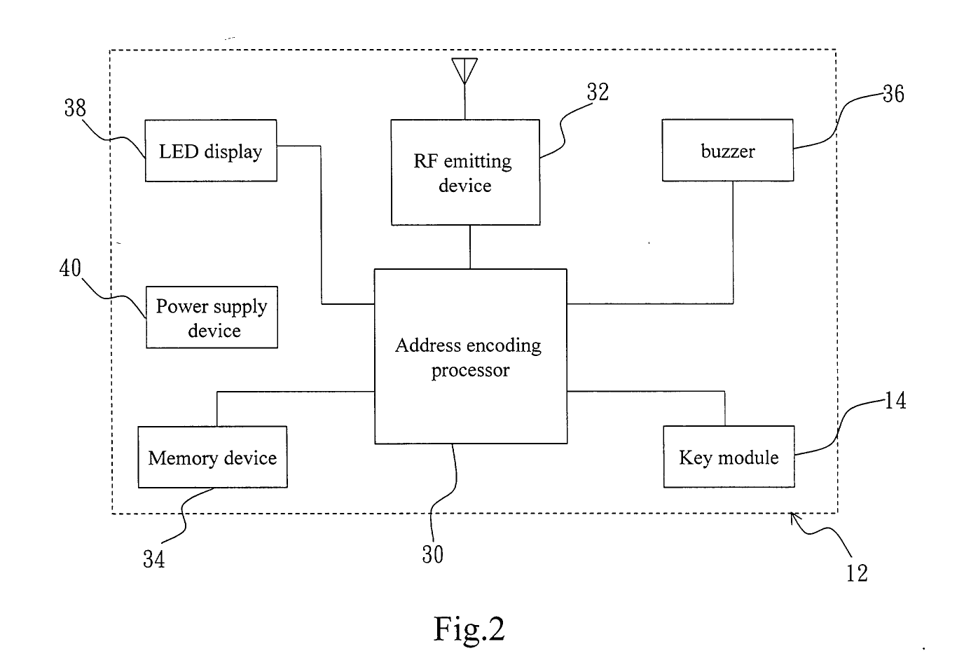

As shown in FIG. 2, the handheld remote-control module 12 comprises an address encoding processor 30, which is respectively connected to the key module 14, an RF emitting device 32, and a memory device 34. The memory device 34 is usually an electrically erasable programmable read-only memory (EEPROM). The address encoding processor 30 receives the keyed-in internal codes of the key module 14 to generate multi-stage remote-control digital codes, which are stored in the memory device 34. When a user wants to adjust the brightness of a light bulb 20 and presses the key module 14, the address encoding processor 30 will transmit a multi-stage remote-control digital code to the RF emitting device 32, which emits out a remote-control signal to the light adjustment device 16. The handheld remote-control module 12 also has a buzzer 36 and an LED display 38 therein, which are connected to the address encoding processor 30. During remote control, the buzzer 36 will give out sound to ensure input, and the LED display 38 will give out light to display emitting state. A power supply device 40, usually being a battery set, is provided to supply the required electricity for the above subassemblies.

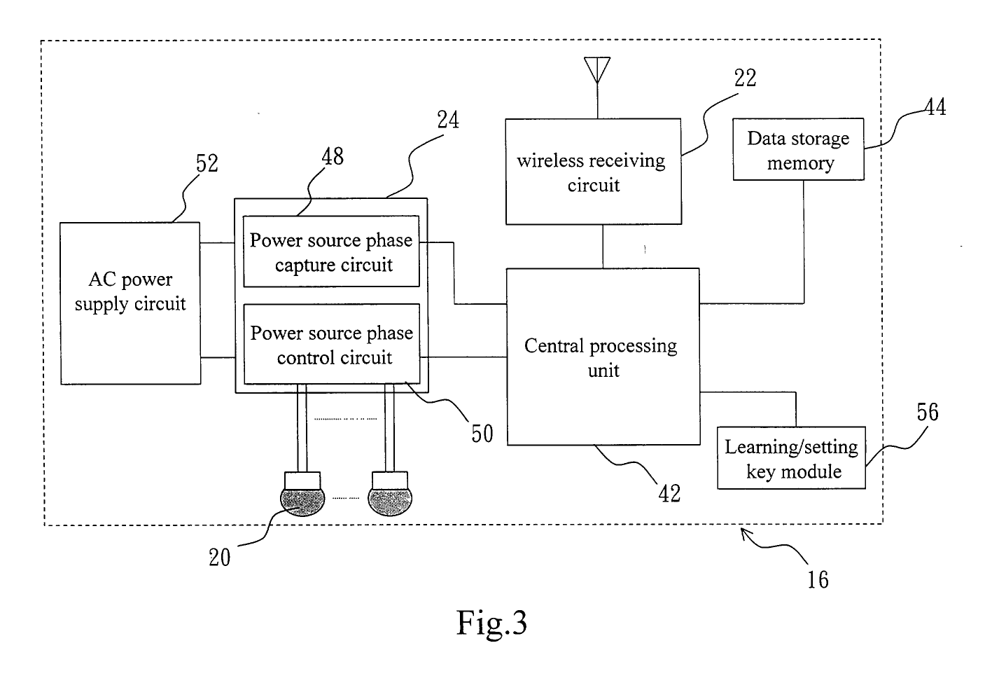

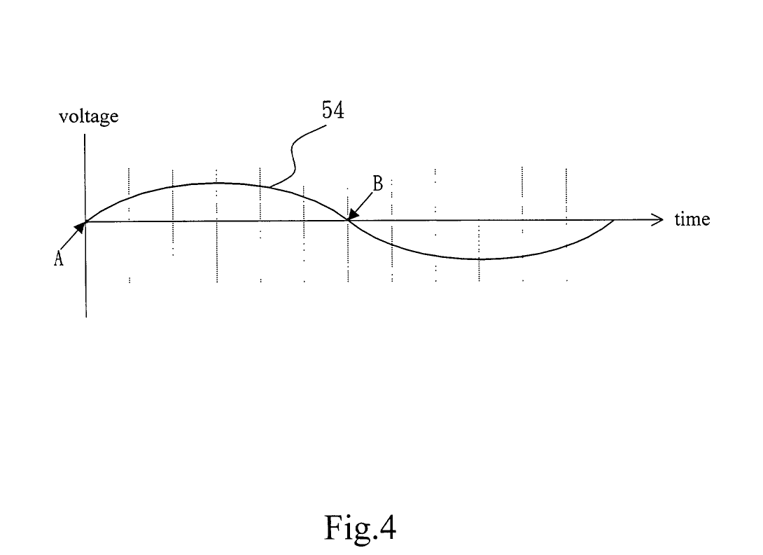

As shown in FIG. 3, the light adjustment device 16 comprises a central processing unit (CPU) 42 connected to the wireless receiving circuit 22, a data storage memory 44, and the brightness control module 16. The brightness control module 16 comprises a power source phase capture circuit 48 and a power source phase control circuit 50. The wireless receiving circuit 22 receives the remote-control signal emitted by the handheld remote-control module 12 to let the CPU 42 discriminate the remote-control signal according to the inbuilt remote-control serial code of the handheld remote-control module 12 stored in the data storage memory 44. After confirmed, a control signal is sent to the brightness control module 16 to set the power source phase capture circuit 48 and the power source phase control circuit 50, which are connected to an AC power supply circuit 52. The power source phase capture circuit 48 is used to capture the present AC phase of the AC power supply circuit 52 and transfer this information to the CPU 42, which controls the power source phase control circuit 50 according to each multi-stage remote-control digital code so that the power source phase control circuit 50 can pick different start points on the AC phase for outputting different electricity to the connected light bulb 20. FIG. 4 shows a pulse wave 54 provided by the AC power source circuit 52. The x-axis represents time, while the y-axis represents output voltage. The area covered is equivalent to the output power of the power source. Generally, when the ON key is pressed at the first time, the picked start point is A position of the pulse wave 54 to let the power source be on all the period, hence letting the light bulb be the brightest. Continuous pressing of the ON key will shift rightwards the picked start point of the pulse wave 54 to change the effective period of the pulse wave 54, hence gradually reducing the covered area, i.e., gradually reducing the output power to the light bulb 20. The brightness of the light bulb 20 will thus be gradually weakened. When the picked start point is at B position, the brightness of the light bulb 20 is the weakest. On the other hand, when one wants to totally turn off the light bulb, he presses the OFF key once to turn off the power source 16 of the light adjustment device 16.

The above CPU 42 is further connected to learning/setting key module 56. A user can learn serial codes of different remote controllers so that the handheld remote-control modules 12 having different remote-control serial codes can simultaneously control a plurality of sets of the light adjustment devices 16. Moreover, the user can use the learning/setting key module 56 to learn the internal codes of the light adjustment device 16 and the derived multi-stage control codes so that he can use the learning/setting key module 56 to control the brightness of the light bulb 20 without using the handheld remote-control module 12.

In the present invention, the design of the wireless remote-control light adjuster 10 can provide the function of a far-end remote-control light adjustment device 16 for the user to avoid the inconvenience caused by the need that he goes to the light adjustment device 16 for operation himself. The handheld remote-control module 12 is used to copy and learn internal codes of a plurality of sets of the light adjustment devices 16. The different keys 18 on the same handheld remote-control module 12 are used to adjust a plurality of sets of the light adjustment devices 16. Through continuously pressing the same key 18 on the handheld remote-control module 12 many times, the light adjustment device 16 corresponding to the key 18 can achieve multi-stage remote control of the light intensity of the light bulb 20.

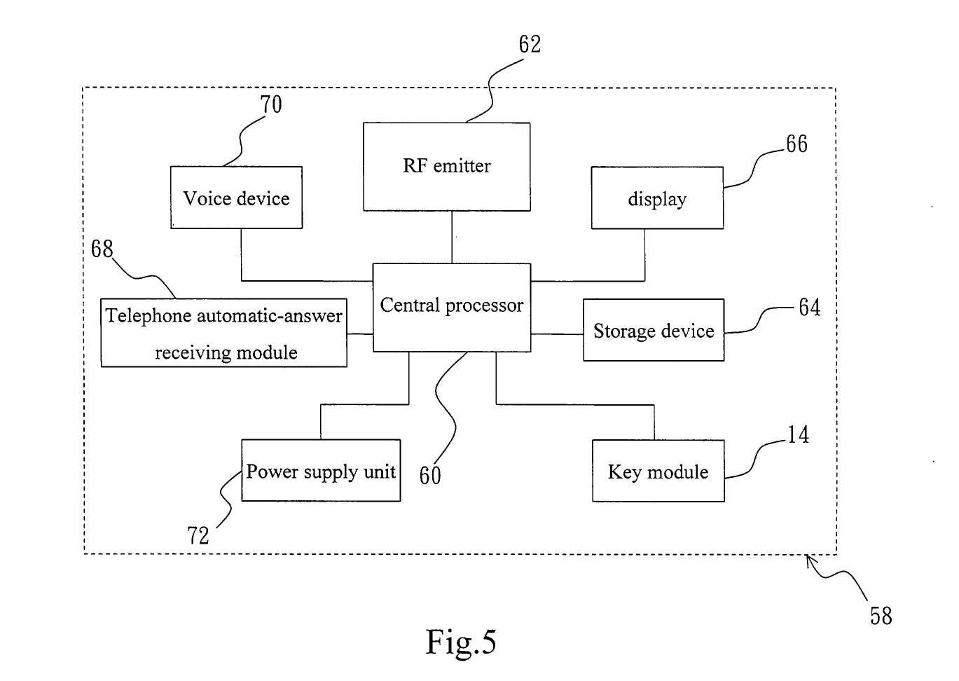

On the other hand, in addition to wirelessly controlling the light adjustment device 16 using the above handheld remote-control module 12, a telephone far-end remote-control module 58 can be used to control the light adjustment device 16. As shown in FIG. 5, the telephone far-end remote-control module 58 comprises a central processor 60 connected to the key module 14, an RF emitter 62, a storage device 64, a display 66, a telephone automatic-answer receiving module 68, and a voice device 70. The central processor 60 receives the keyed-in internal code of the key module 14 to generate a multi-stage remote-control digital code, which is displayed on the display 66 and stored in the storage device 64. The telephone automatic-answer receiving module 68 is connected to a public telephone switching system. When a user enters the telephone far-end remote-control module 28 via a telephone line, the voice device 70 will provide operation indications for him to achieve simple operation. Meanwhile, the telephone automatic-answer receiving module 68 will transfer the received telephone multi-frequency signals to the central processor 60, which will send out a control signal to be emitted out by the RF emitter 62, hence setting and controlling the light adjustment device 16. The central processor 60 is also connected to a power supply unit 72 for providing electricity for the whole telephone far-end remote-control module 58. A telephone multi-frequency signal discriminator (not shown) can further be disposed between the telephone automatic-answer receiving module 68 and the central processor 60 to provide discrimination of code for the user, thereby securing safety of use of the light adjustment device.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A wireless remote-control light adjuster, comprising:
a light adjustment device connected to at least a light bulb, said light adjustment device having a wireless receiving circuit disposed therein for receiving a remote-control signal to control the operation of a brightness control module in said light adjustment device; and
a remote-control module having a key module for input of an internal code of said light adjustment device, said remote-control module being used to learn said internal code and generate a plurality of remote-control digital codes so as to emit out said remote-control signal having different remote-control digital codes according to change of pressed times of said key module.

2. The wireless remote-control light adjuster as claimed in claim 1, wherein said light adjustment device comprises a central processing unit connected to said wireless receiving circuit, a data storage memory, and said brightness control module, said wireless receiving circuit receiving said remote-control signal emitted by said remote-control module and letting said central processing unit discriminate said remote-control signal according to said internal code set in said data storage memory to send a control signal to said brightness control module, said brightness control module comprising a power source phase capture circuit and a power source phase control circuit, said power source phase control circuit being connected to at least one of said light bulb, a power supply circuit connected to said brightness control module being also provided.

3. The wireless remote-control light adjuster as claimed in claim 2, wherein said central processing unit controls the output power of said brightness control module by sending the effective period of a continuous pulse wave.

4. The wireless remote-control light adjuster as claimed in claim 2, wherein said central processing unit is further connected to a learning/setting key module.

5. The wireless remote-control light adjuster as claimed in claim 1, wherein said remote-control module is selected among a handheld remote-control module and a telephone far-end remote-control module.

6. The wireless remote-control light adjuster as claimed in claim 5, wherein said handheld remote-control module comprises an address encoding processor respectively connected to said key module, an RF emitting device, and a memory device, said address encoding processor being used to receive said keyed-in internal code of said key module and generate said multi-stage remote-control digital code stored in said memory device, said central processing unit sending said multi-stage remote-control digital code to said RF emitting device, which emits out a remote-control signal, a power supply device being also provided to supply the required electricity for each said component.

7. The wireless remote-control light adjuster as claimed in claim 6, wherein said address encoding processor is connected to a buzzer.

8. The wireless remote-control light adjuster as claimed in claim 6, wherein said address encoding processor is further connected to an LED display.

9. The wireless remote-control light adjuster as claimed in claim 5, wherein said telephone far-end remote-control module comprises a central processor connected to said key module, an RF emitter, a storage device, and a display, said central processor being used to receive said keyed-in internal code of said key module to generate said multi-stage remote-control digital code, which is displayed on said display and stored in said storage device, a telephone automatic-answer receiving module for receiving the telephone signal of a telephone line being connected to said central processor, said central processor sending out said control signal to be emitted out by said RF emitter after processing, a power supply unit connected to said central processor being also provided.

10. The wireless remote-control light adjuster as claimed in claim 9, wherein said central processor is connected to a voice device.

11. The wireless remote-control light adjuster as claimed in claim 9, wherein a telephone multi-frequency discrimination device is further disposed between said telephone automatic-answer receiving module and said central processor.
